(19) United States
(12) Patent Application Publication
(10) Pub. No.: US 2012/0209723 A1
(43) Pub. Date: Aug. 16, 2012

(54) PITCH DEVELOPMENT METHOD

(76) Inventors: Paula Satow, Scottsdale, AZ (US); Mike Eisele, Paradise Valley, AZ (US)

(21) Appl. No.: 13/371,164

(22) Filed: Feb. 10, 2012

Related U.S. Application Data
(60) Provisional application No. 61/441,534, filed on Feb. 10, 2011.

(51) Int. Cl. G06Q 99/00; G06Q 30/02; G06Q 10/00

(52) U.S. Cl. 705/14.72; 705/1.1; 705/319

(57) ABSTRACT

An apparatus, system, and method of developing a pitch through procurement of textual entries from a user through a series of questions and then compiling these textual entries in a specified manner to create a pitch. The pitch may be edited and revised by the user to create final form. The pitch may be revised, modified, or commented on by a second user. The pitch may then become part of a user profile on a computer network of users, some of whom may have also developed pitches.

### CROSS-REFERENCE TO RELATED APPLICATIONS

This application is a non-provisional of and claims priority to U.S. Provisional No. 61/441,534, filed on Feb. 10, 2011 and entitled “Pitch Development Method”, wherein such provisional application is hereby incorporated by reference in its entirety.

### FIELD OF INVENTION

This application is directed to a method for developing an elevator pitch and more particularly to a defined, repeatable process for individuals or groups to create and share a brief pitch [message, story, or “elevator pitch” or “elevator speech”].

### BACKGROUND OF THE INVENTION

You know the feeling. You're on the elevator heading to the office and your company's CEO steps on right behind you. This is your moment. This is your chance to stand out and shine. But you can't think of what to say—how to convey a succinct, effectively communicated message that will make a good impression. Or how about this one? You're on a first date with a very attractive and like-minded single and you want to say just the right thing to capture their interest In both these cases, and so many more just like them, you try to make a case for yourself but inevitably think to yourself later. “Why didn't I say this?” “Why didn't I think of that?' Typical pitches often lack clarity, focus and excitement. Yet, that's just what you need most sell your skills, products, services or ideas.

An “elevator pitch” is a brief message or promotional tool, typically 30 seconds but can be more or less, that helps you sell an idea or product or service to your target audience. The pitch should be short, approximately the time available in a typical elevator ride. Effective communication technique would recommend thoroughly addressing the factual and emotional needs of the audience and positioning the speaker with a unique and most effective answer to those needs. Due to the complexity of effective communication, the lack of any standard format, combined with the increasingly small amount of time available in our hurried society to convey a clear and concise story, pitches are difficult to create. Thus many elevator pitches frequently overlook information that is important for selling an idea, and at the same time, contain information that is unfocused and ineffective. Second, many pitches have a tendency to try to tell a complete story while leaving nothing out. This “everything but the kitchen sink” approach makes it difficult to describe what is important in the relatively short time available to deliver the pitch. For example, a person may have approximately 30 seconds or 100 words to give the pitch before an audience runs out of time, loses interest or even understands an idea. Further, in our Internet-based age, there is more of a need than ever to have a pitch ready at any given moment, the improve a resume, sell a product or enhance a social media profile.

Thus, a need is growing for a repeatable, standardized process to simplify a complex message and turn it into an effective, powerful 30-second pitch. Further, a need exists to develop and distribute such a pitch in an efficient manner. Moreover, a need exists to develop steps that guide a user in discovering for themselves and authoring all the needed elements of a powerful pitch, and at the same time, remaining concise. Those elements include processes for discovering factual, “left brain” information, and emotion-led, “right brain” information, which can then be improved via a final integrative “whole brain” synthesis process.

### SUMMARY OF THE. INVENTION

An apparatus, system, and method of developing a pitch through elicitation of statements from a use through a series of questions and then compiling these statements in a designated manner to create a pitch. The pitch may be edited and revised by user to create final form. The pitch may then become part of a user profile on a computer network of users some of whom may have also developed pitches.

### BRIEF DESCRIPTION OF THE DRAWING FIGURES

FIG. 1 illustrates an embodiment of an electronic display prompting a user to select the type and/or subject of the pitch.

FIG. 2 illustrates an embodiment of an electronic display that prompts the user to answer certain questions.

FIG. 3 illustrates an embodiment of an electronic display prompting answers to two specific questions relating to the subject of the pitch and the audience of the pitch.

FIG. 4 illustrates an embodiment of an electronic display showing a draft pitch.

FIG. 5 illustrates an embodiment of an electronic display prompting a user to enter a summary of a pitch.

FIG. 6 illustrates an embodiment of an electronic display prompting a user to select people to review the user's pitch.

FIG. 7 illustrates an embodiment of an electronic display that permits a user to publish the user's pitch to the Internet.

FIG. 8 illustrates an embodiment of an electronic display showing a finished pitch.

### DETAILED DESCRIPTION

The detailed description of exemplary embodiments herein makes reference to the accompanying drawings and pictures, which show the exemplary embodiment by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments”, “one embodiment”, an embodiment“, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of The following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; marketing data; user tracking data and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers. A user may include any individual, business, entity, government organization, software and/or hardware that interact with a system.

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may he used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the Internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In an embodiment, various components, modules, and/or engines of system may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein,

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, sec the NIST's (National Institute of Standards and Technology) definition of cloud computing at http://esrc.nist.gov/groups/SNS/cloud-computing/cloud-def-v15.doc (last visited Feb. 4, 2011), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Phrases and terms similar to an “item” or “subject” may include anything about which the pitch method is designed to communicate to a target audience and may include an individual, good, service, information, experience, data, place, content, access, rental, lease, contribution, account, benefit, right, reward, coupons, monetary equivalent, anything of value, something of minimal or no value, monetary value, non-monetary value and/or the like. The “subject category” as used herein is the general category in which the specific “subject” or “item” can be categorized.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate tile systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 File structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the user's access permissions or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may he configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perk PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), MAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, MAX, WSDL and UDDI. Web services methods are well known in the art, and are covered in many standard texts, See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may he realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3)“Cryptography & Network Security: Principles & Practice” by William Stallings, published by Prentice Hall; all of which are hereby incorporated by reference.

A user is equipped with a computing device in order to interact with the system and facilitate online information retrieval and exchange. The user has a computing unit in the form of a personal computer, although other types of computing units may be used including laptops, notebooks, hand held computers, set-top boxes, cellular telephones, touch-tone telephones and the like. The host has a computing unit implemented M the form of a computer-server, although other implementations are contemplated by the system.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Various embodiments of the present invention comprise a repeatable process that guides a user to develop a pitch. A “pitch” may be defined as a written, audio, video, movie, film, and/or verbal statement of between approximately 50 and 150 words, and which can be spoken in a period of between approximately 20 and 40 seconds that effectively conveys a message, e.g. a promotional tool. In an embodiment, the pitch contains approximately 100 words and may be spoken in approximately 30 seconds. The pitch is intended to effectively and succinctly explain, convey, and/or summarize any topic, by identifying and organizing a series of communication elements that are coordinated in an effective sequence. These communication elements include the target audience, describing a problem they need to solve and a solution for that problem including a clear call to action, distinguishing the solution from other solutions, describing the skills that enable the solutions, and eliciting the emotional rewards for both the audience and the source of the solution. This invented process uses a series of steps and new techniques that guide the user to identify and organize all of these communication elements in the available time and word budget.

Further, various embodiments comprise a step-by-step, repeatable architecture and method to create a pitch. A finished pitch may be used, for example, to add a summary of ability to a resume, to summarize a person's qualifications in a job interview, to enhance an online dating profile, to summarize an invention, to write an abstract for a research paper, to summarize a marketing plan in business, and to create pitches for numerous other uses or purposes that might benefit from a brief, effective pitch.

In accordance with an embodiment, the pitch development process comprises the following steps:

Step 1

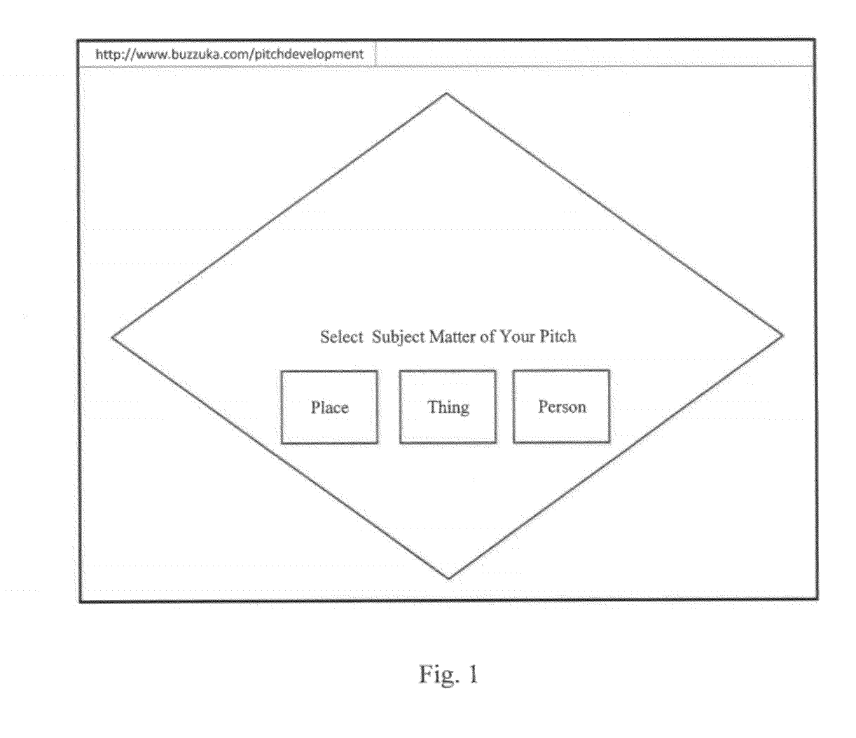

In this step, according to an embodiment, the user selects the type or subject of the pitch and a computer receives the selection. For example, the subject of the pitch may be a person, place, or thing. The subject of a “person” pitch may include a person, a person's career, a person's job, and the like. The subject of a “place” pitch may include a person's company, a person's department, a person's school, a person's volunteer organization, and the like. The subject of a “thing” pitch may include an idea, a good, an abstract, a book outline, a patent summary, and the like. FIG. 1 illustrates an embodiment of an electronic display prompting a user to select the type and/or subject of the pitch. A user may be prompted to give a title to his pitch in order to facilitate feedback for and/or distribution of the pitch.

Step 2

In this fact-finding step, the user answers questions pertaining to the type and/or subject of the pitch selected in Step 1 by making a textual entry into a text box. In one embodiment, a user may be prompted to answer up to five questions. These questions are designed to help the user discover, develop, and outline his pitch. These prompted questions are context specific, and based on the selection of the person, place, or thing context the user selected in step 1 for the subject of the pitch. In an embodiment the five questions can be directed toward eliciting responses from the left brain or analytical part of the brain.

The five questions can he advantageously designed to contemplate various factors, including the target audience, the target audience's problem, a potential and/or proposed solution for the problem, unique aspects of the subject of the pitch and/or the potential/proposed solution, and benefits of the potential/proposed solution. The five questions may be answered and/or reanswered in any order. This iterative capability of the tool is a unique way that aids the user in discovering the content of their pitch. These items may he advantageously determined to be important in developing the pitch.

In accordance with various embodiments, the questions are context specific. For example, the questions may be phrased in a particular fashion depending on the type of the pitch and/or the other information presented by the user. Further, the sequence of the questions may be predetermined and/or determined based on information presented by the user to help guide the user in developing a desirable pitch. Additionally, the questions may be presented in a format that gives the user the ability to reform and edit answers to the questions individually and/or as a group.

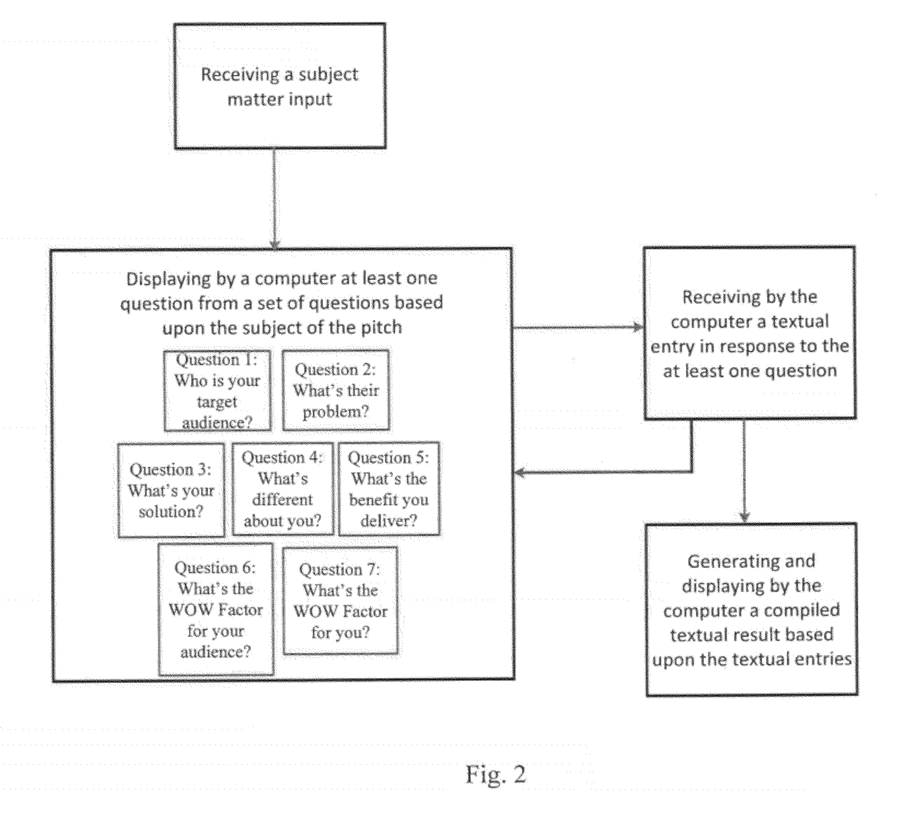

In an embodiment, the pitch development method provides context specific coaching and gives examples to guide the user. This method can provide feedback if a user fails to answer any of the questions. FIG. 2 illustrates an example of an electronic display that prompts the user to answer certain questions. The design layout of the electronic display in FIG. 2 purposely helps the user maintain the brevity needed to create an effective pitch in the time and word budget available.

In an embodiment, the context specific questions, coaching, and/or help may determined at least in part based on certain subcategories. For example, “person” subcategories may include spiritual self, social self, family self, work self. Similarly, more specific context help can be extended to “place” and “thing” categories as well. In an embodiment, the coaching may also by accompanied by context specific examples of answers to questions. The types of questions presented in Step 2 allow for factual answers, and therefore users are typically accessing left-brain functions. These factual answers help the user engage the process and develop confidence in their results. Our experimentation shows that completing Step 2 is a significant aid to subsequently completing Step 3. Better pitches result when Step 2 preceeds Step 3.

Step 3

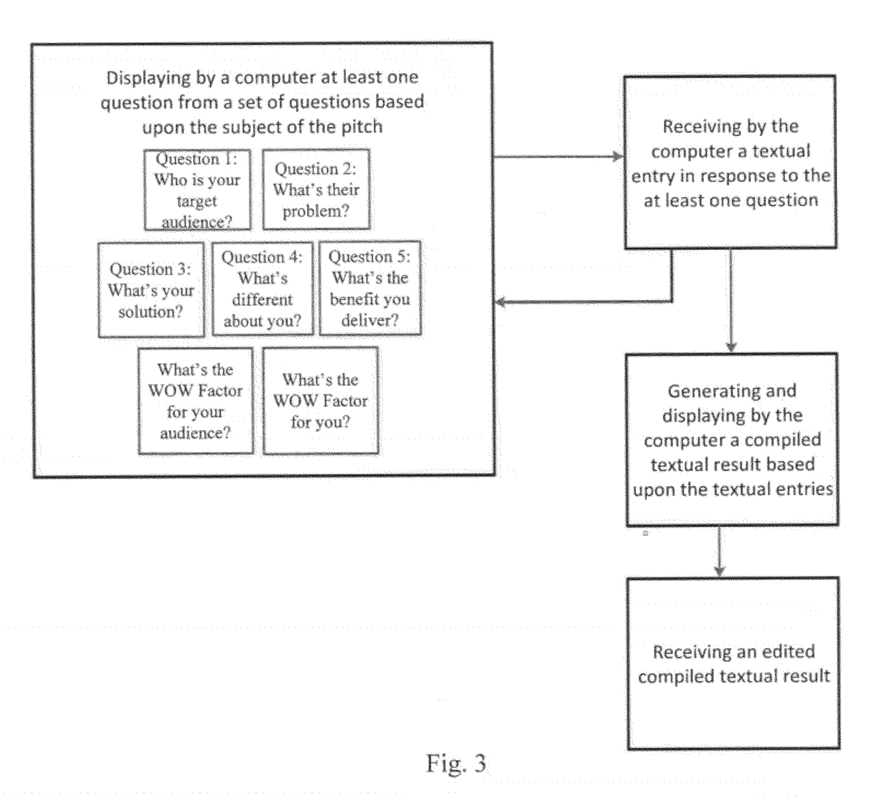

In various embodiments, the user completes exercises configured to elicit feelings, by determining the emotional needs of the audience for the pitch and the emotional connection of the user to their audience. In an embodiment, two questions can be directed toward eliciting a response from the right brain or creative brain, or eliciting a response that elicits a reaction from the recipient of the pitch containing the responses to the two marketing questions. For example, with reference to FIG. 3, two specific questions may be utilized: (1) “What is the WOW Factor for your audience?”; and “What is the WOW Factor for you?” These and other similar questions are uniquely configured to focus on and ascertain the emotional side of the communications process in order to develop a desirable pitch. The design layout of the electronic display in FIG. 3 purposely helps the user maintain the brevity needed to create an effective pitch in the time and word budget available.

These questions go beyond simply a fact-oriented focus and are configured to help the user can connect quicker and better with their audience by accessing right-brain related emotions and passion. This process is configured to provide the context specific phrasing of the questions, the sequence of the questions that helps guide the user, and the ability to reform and edit answers to the exercises individually and/or as a group. This process provides context specific coaching and gives examples to guide the user. This process provides feedback if a user fails to answer any of the questions.

The short term memory of the average human brain can retain three to seven pieces of information. An exemplary pitch method is designed not to overtax the average recipient's short term memory, and thus, be retained and memorable. Thus, a preferred embodiment displays and receives textual entries in response to live questions from the first set of questions, designed to elicit a left brain response, and two questions from the second set of questions, designed to elicit a right brain response. While five and two may be preferred, other ratios of right and left brain questions/responses are contemplated.

Step 4

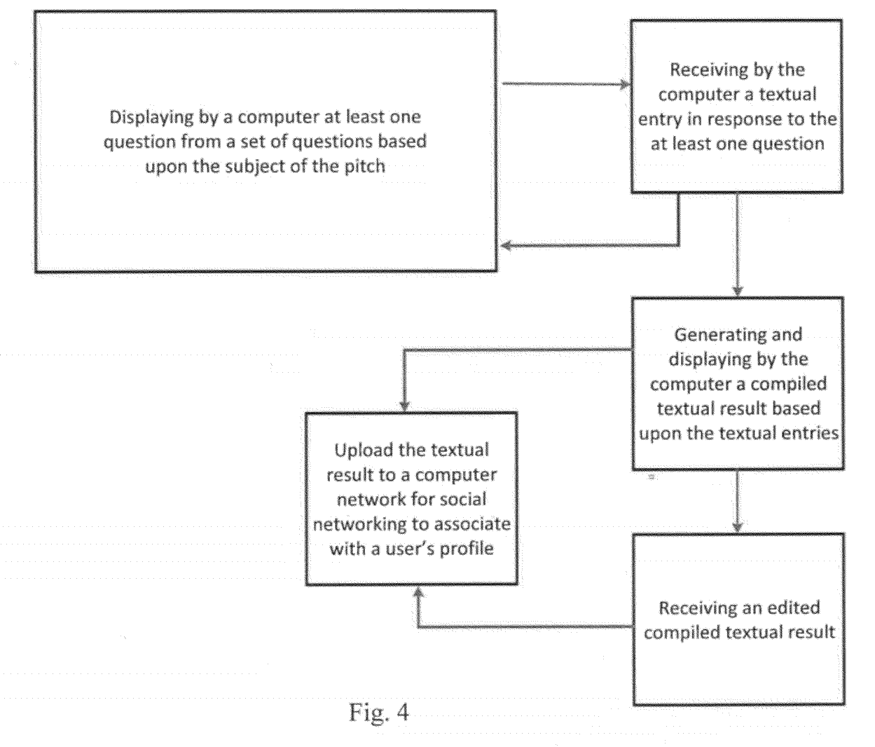

Various embodiments of the present invention comprise a method for finishing the pitch, by reorganizing and rearranging the information created in Steps 2 and 3 in a unique, and novel sequence, manner, and/or format. This sequence is then presented to the user as an editable draft of the user's pitch, with prompting that elicits a whole-brain method of editing by the user. Various embodiments may utilize varying degrees of artificial intelligence to add appropriate ordering and phraseology to the user's answers where appropriate to improve and/or enhance the pitch. After the user edits the draft pitch created by this process, the method proceeds to the next step. This process provides context specific coaching and gives examples to guide the user. This process also provides feedback if a user fails to answer any of the questions. An example of Step 4 is illustrated in FIG. 4. The design layout of the electronic display in FIG. 4 purposely helps the user maintain the brevity needed to create an effective pitch in the time and word budget available.

Step 5

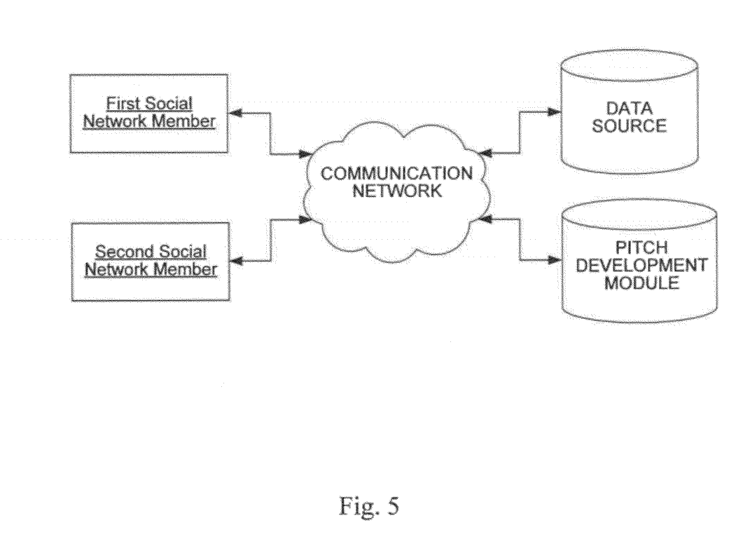

After editing he pitch, in an embodiment, the user is prompted to provide a short summary of their pitch. This short summary may comprise one sentence, and may be referred to as a “blurb” or “10 second pitch.” As with the other steps, this process provides context specific coaching and gives examples to guide the user. This process also provides feedback if a user fails to answer any of the questions. Further, this short summary provides the user with a version of their pitch that can he spoken very briefly, for example, in less than approximately five to fifteen seconds. An example of Step 5 is illustrated in FIG. 5. The design layout of the electronic display in FIG. 5 purposely helps the user maintain the brevity needed to create an effective pitch in the time and word budget available.

Step 6

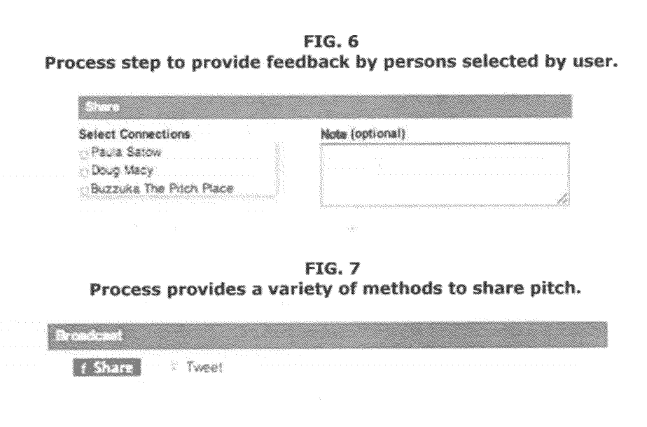

In accordance with an embodiment, it may he desirable for the user to obtain feedback regarding the pitch developed according to the present invention. For example, the user may he provided methods for receiving feedback from persons designated by the user. In an embodiment, the feedback may be solicited from other people who have used the process disclosed herein to develop their own elevator pitch. Further, in an embodiment, a person may he linked to other users of the pitch development process, and these linked users may be displayed so that the user can select which of the linked users to review the draft pitch. An example of Step 6 is illustrated in FIG. 6.

Step 7

Further, in accordance with an embodiment, it may be desirable for the user to publish their pitch on Internet websites of their choosing and/or a computer network. For example, the user may be a social networker and publish their pitch on social networking web sites and/or other web sites where information may be exchanged and/or discussed. Such publishing may result in further feedback after which the pitch may be modified. Further, such publishing may allow the user to publish and/or send his pitch to those people and/or entities for which the pitch was designed. An example of Step 7 is illustrated in FIG. 7. The pitch may be published or become part of the user's profile. In various embodiments, a second user or second social networker may provide input to a certain user's published pitch and/or may collaborate in developing the pitch. Such input may be substantially simultaneous via the computer network. Alternatively, such input may he solicited from the second user by sending a request via the computer network. Embodiments of the method disclosed herein may utilize these inputs in generating and/or improving the pitch.

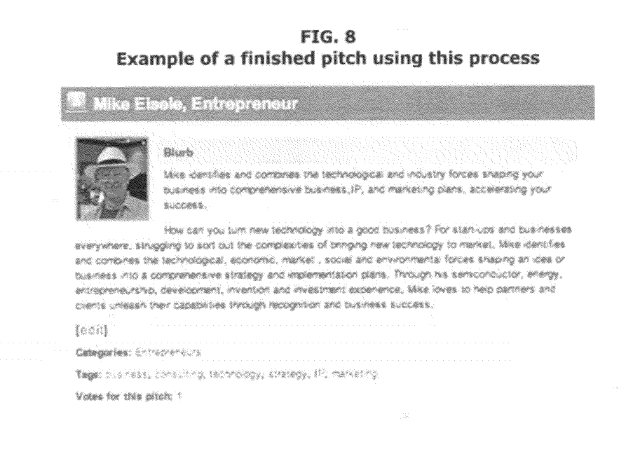

After the above steps have been utilized, and in accordance with various embodiments, a finished pitch may be presented to the user. FIG. 8 illustrates an example of a finished pitch developed utilizing a method according to embodiments of the present invention. The finished pitch may be configured to be searchable, for example, through an Internet search engine or by other users of the pitch development website. The pitch may be searchable by name, title, tag, author, category, and the like. In an embodiment, the user may request different outputs for the pitch. For example, the user may request that the pitch be more or less detailed than the generated pitch.

According to a further embodiment, the user may have the option of receiving the finished pitch in a number of different formats. The user may have the option of associating a photo with the pitch. In an embodiment, the user may have the option of requesting translation of the finished pitch and/or receiving the pitch in different languages. Further, the finished pitch may be provided to the user in an audio-visual format. Additionally, the user may request that the pitch be embedded in various promotional materials including an internet website, flyer, brochure, email, letter, single or double-sided post card or business card, workbook, book, and/or other intangible or tangible forms. Moreover, the pitch may be supplemented with pictures, related websites, reference materials, and/or other material supplied by the user or determined by methods according to embodiments of the invention disclosed and/or contemplated herein. Such promotional materials can be created by providing promotional material templates such that a template is auto-populated from fields within a user profile, such as a name, a picture, a pitch, contact information, website etc.

With a social network, groups can be formed to collaborate on the development of the pitch so that a pitch can be developed for a single user within the group or can be developed for the group, the members of which have a common interest to be promoted.

In accordance with various embodiments, the steps outlined above may be carried out on a computing device such as a personal computer, a hand-held computer, a personal digital assistant, a cellular telephone, and/or any other device capable of displaying text, graphic, information, data and/or combinations thereof. A computer-readable medium may provide instructions to a processor contained in the device, and the processor, in response to execution of the instructions, may cause the device to perform the steps listed above and other steps contemplated by the present invention. The steps may be shown to user through a graphical user interface, a web page, an electronic display, and the like.

In other embodiments, some and/or all of the various steps may be presented in a non-electronic format. For example, a different paper form may be utilized depending on various factors such as the subject of the pitch and/or the desired audience for the pitch.

Various principles of the present invention have been described in embodiments. However, many combinations and modifications of the above-described structures, arrangements, proportions, and elements, used in the practice of the invention, in addition to those not specifically described, can be varied without departing from those principles. Various embodiments have been described as comprising automatic processes, but these processes may be performed manually without departing from the scope of the present invention. Moreover, where a phrase similar to “at least one of A, B, and C” is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

We claim:

1. A computerized pitch development method comprising
receiving, by a computer, a selection for a subject area of a pitch;
displaying, by the computer and in response to the receiving, at least one first question from a first set of questions based upon the subject of the pitch selected;
receiving, by the computer, a first textual entry wherein the first textual entry is a response to the first question;
displaying, by the computer, at least one second question from a second set of questions;
receiving, by the computer, a second textual entry wherein the second textual entry is a response to the second question;
generating and displaying, by the computer, a compiled textual result wherein the compiled textual result comprises all textual entries arranged in a specified order.

2. A pitch development method of claim 1, wherein the first set of questions are designed to solicit information on at least one of the following: a target audience, the target audience's problem or need; a solution to the problem or need; or benefits to the solution

3. A pitch development method of claim 2, wherein the second set of questions are designed to solicit information on at least one of the following: an attention grabbing statement for the target audience and an attention grabbing question for the target audience, wherein the attention grabbing statement or question makes the target audience want to learn more about the subject of the pitch, ask a question, or buy a product or service.

4. A pitch development method of claim 1, wherein the first set of questions is designed to solicit a left brained response and the second set of questions is designed to solicit a right brained response.

5. A pitch development method of claim 4, wherein five first textual entries are received based on a user's response to five first questions selected from the first set of questions and two second textual entries are received based on a user's response to two second questions selected from the second set of questions.

6. A pitch development method of claim 5, wherein the subject area comprises a person, thing, or place.

7. A pitch development method of claim 6, further comprising receiving, by the computer, a fourth textual entry of the compiled textual result rearranged or edited by the user to create the pitch.

8. A pitch development method of claim 7, further comprising, uploading, by the computer, to a computer network for social networking the pitch to associate with a user's profile.

9. A computer system comprising a computer program executing on the system wherein the program:
receives a selection for a subject area of a pitch;
displays, in response to the receiving, a first question based upon the subject of the pitch selected wherein the first question is selected from a first set of questions designed to solicit information on at least one of the following: a target audience, the target audience's problem or need; a solution to the problem or need; or benefits to the solution;
receives a first textual entry in response to the first question;
displays a second question selected from a second set of questions;
receives a second textual entry in response to the second question;
generates and displays compiled textual result wherein the compiled textual result comprises all textual entries arranged in a specified order.

10. A computer system comprising a computer program of claim 9, wherein the second set of questions are designed to solicit information on at least one of the following: an attention grabbing statement for the target audience and an attention grabbing question for the target audience, wherein the attention grabbing statement or question makes the target audience want to learn more about the subject of the pitch, ask a question, or buy a product or service.

11. A computer system comprising a computer program of claim 10, wherein the program displays a third question on a computer-generated display wherein the third question is designed to solicit information on what makes a user passionate or excited about the subject of the pitch, and receiving a third textual entry wherein the third text entry is a response to the third question.

12. A computer system comprising a computer program of claim 11, wherein the subject area comprises a person, thing, or place.

13. A computer system comprising a computer program of claim 12, wherein the program receives a fourth textual entry of the compiled textual result rearranged or edited by the user to create the pitch.

14. A computer system comprising a computer program of claim 13, wherein the program uploads the pitch to a computer network for social networking in association with the user's profile on the network.

15. A computer network for a social networking environment:
a communications network;
a plurality of client devices, said client devices providing a graphical user interface for social networking to a plurality of social networkers;
a database including information about said plurality of social networkers, wherein the graphical user interface enables a first social networker of said plurality of social networkers to:
create a pitch, wherein the pitch represents a promotional tool of the first social networker;
display the pitch on a profile page associated with the first social networker subsequent approval of the first social networker.

16. The computer network of claim 16, wherein the graphical user interface enables a first social networker of said plurality of social networkers to convey the pitch to a second social networker to enable the second social networker to edit or revise the pitch.

17. The computer network of claim 16, form a group and invite a plurality of users join group to collaborate on a pitch.

18. The computer network of claim 17, wherein the group has a group profile and the pitch to be developed by the group is related to the group profile.

19. The computer network of claim 15, create a promotional material based on a template.
